(19) United States
(12) Patent Application Publication
(10) Pub. No.: US 2013/0058119 A1
(43) Pub. Date: Mar. 7, 2013

(54) VEHICLE ROOM LAMP

(71) Applicant: Shingo Chiba, Makinohara-shi (JP)

(72) Inventor: Shingo Chiba, Makinohara-shi (JP)

(73) Assignee: YAZAKI CORPORATION, Tokyo (JP)

(21) Appl. No.: 13/696,732

(22) PCT Filed: Apr. 19, 2011
(86) PCT No.: PCT/JP2011/059620

§ 371 Date: Nov. 7, 2012

(30) Foreign Application Priority Data
May 10, 2010 (JP) 2010-108364

(51) Int. Cl. F21V 5/04

(52) U.S. Cl. 362/520

(57) ABSTRACT

There is provided a vehicle room lamp including a lamp assembly including a resin clip, a roof panel having an opening and a reinforcement having an opening. The resin clip is locked to a peripheral edge of the opening of the reinforcement through the opening of the roof panel. The resin clip is an elastic body formed in an inverted U shape including a base portion connected to the housing, an inverted U-shaped portion connected to the base portion, and a lock connected to the inverted U-shaped portion. The resin clip has an extending portion extending downward at a protruding piece at a lower end of the lock. A peripheral edge of the opening of the roof panel reaches a vicinity of the extending portion in a state where the resin clip is locked to the peripheral edge of the opening of the reinforcement.

### TECHNICAL FIELD

The present invention is related to a vehicle room lamp.

### BACKGROUND ART

Conventionally, as a room lamp mounted to the ceiling of a vehicle interior, a vehicle room lamp as described in PTL 1 is known (see PTL 1).

### CITATION LIST

### Patent Literature

[PTL 1] JP-A-2005-001459

A mounting structure of a lamp unit described in PTL 1 enables the lamp unit and an interior wall material to be simply and reliably assembled to a vehicle body panel at the same time. Specifically, fixing means for fixing a room lamp and a reinforcement to each other is provided with a flexible arm which is provided to be suspended on the reinforcement side of a holder and is bent in an inverted U shape and of which an end tip portion is locked to a mounting portion of the reinforcement, and a flexible arm restriction portion which is arranged on a side of the flexible arm and is engaged with a support piece of the flexible arm to restrict the end tip portion from displacing along the direction of vehicle body attachment and detachment of the room lamp.

According to the mounting structure of the lamp unit described in PTL 1, the module may be reliably assembled to the vehicle body panel by the end tip portion of the flexible arm. In addition, the end tip portion of the flexible arm does not come free into the vehicle inside due to the direction of the vehicle body attachment and detachment of the lamp unit during vehicle body assembly, and thus there is no need to set an excessive clearance from the mounting portion of the vehicle body panel for the likelihood of coming free. In addition, there is an advantage that even in a case where a strong external force is exerted on the fixed module toward the interior with respect to the vehicle body panel, the fixing of the flexible arm is not displaced.

### SUMMARY OF INVENTION

### Technical Problem

However, in the case of the mounting structure of the lamp unit described in PTL 1, there is a problem in that in order to form the flexible arm, a slide structure is necessary for a die, resulting in an increase in cost.

In order to solve the problem, an object of the present invention is to provide a vehicle room lamp in which cost is reduced with a shape that does not use a die having a slide structure, and an accurate mounting state can be maintained in which a housing is not suspended and does not cause excessive displacement due to inclination after mounting of a resin clip (described later) that is used for the mounting.

### Solution To Problem

The above-described object of the present invention is achieved by the following configurations.

(1) A vehicle room lamp comprising:

a lamp assembly integrally including a lens, a housing with a resin clip, and a busbar;
a roof panel having an opening; and
a reinforcement having an opening,
wherein the lamp assembly, the roof panel, and the reinforcement are integrally assembled by locking the resin clip to a peripheral edge of the opening of the reinforcement through the opening of the roof panel,
the resin clip is an elastic body, an entire shape of which is formed in an inverted U shape including a base portion connected to the housing, an inverted U-shaped portion connected to the base portion, and a lock connected to the inverted U-shaped portion,
the resin clip has an extending portion that further extends downward at a protruding piece at a lower end of the lock, and
a peripheral edge of the opening of the roof panel reaches a vicinity of the extending portion of the resin clip in a state where the resin clip is locked to the peripheral edge of the opening of the reinforcement.

(2) In the vehicle room lamp in the configuration of (1), a distance between the peripheral edge of the opening of the roof panel and the peripheral edge of the opening of the reinforcement is a length from a hook portion of the resin clip to an end tip of the extending portion.

### BRIEF DESCRIPTION OF DRAWINGS

FIG. 1 is a perspective view illustrating a vehicle room lamp in a state of being assembled to a vehicle according to an embodiment of the present invention.

FIG. 2 is a perspective view of a lamp assembly constituted by the remainder of the vehicle room lamp illustrated in FIG. 1 from which a connector, a roof panel, and a reinforcement are removed.

FIG. 3 is an exploded perspective view of the vehicle room lamp illustrated in FIG. 1.

FIGS. 4A and 4B are diagrams illustrating a resin clip according to the embodiment of the present invention in which a housing is not suspended, where FIG. 4A is a perspective view and FIG. 4B is a longitudinal sectional view.

FIGS. 5A to 5D are longitudinal sectional views illustrating a process up until a lock of the resin clip is locked to the opening peripheral edge of the reinforcement, where FIG. 5A, FIG. 5B, FIG. 5C, and FIG. 5D are diagrams illustrating the situation before primary locking, primary locking, secondary locking, and the reason that the housing is not suspended, respectively.

FIGS. 6A and 6B are diagrams illustrating one of resin clips at the four corners of a housing according to the related art, where FIG. 6A is a perspective view and FIG. 6B is a longitudinal sectional view.

FIGS. 7A and 7B are longitudinal sectional views illustrating a state where the lock of the resin clip illustrated in FIGS. 6A and 6B is locked to the opening peripheral edge of the reinforcement, where FIG. 7A and FIG. 7B are diagrams illustrating secondary locking and the reason that the housing is suspended, respectively.

### DESCRIPTION OF EMBODIMENTS

Hereinafter, a vehicle room lamp in which cost is reduced by considering disuse of a die having a slide structure and a housing is not suspended (described later) after mounting a lamp assembly will be described.

### Configuration of Vehicle Room Lamp As Object of This Embodiment

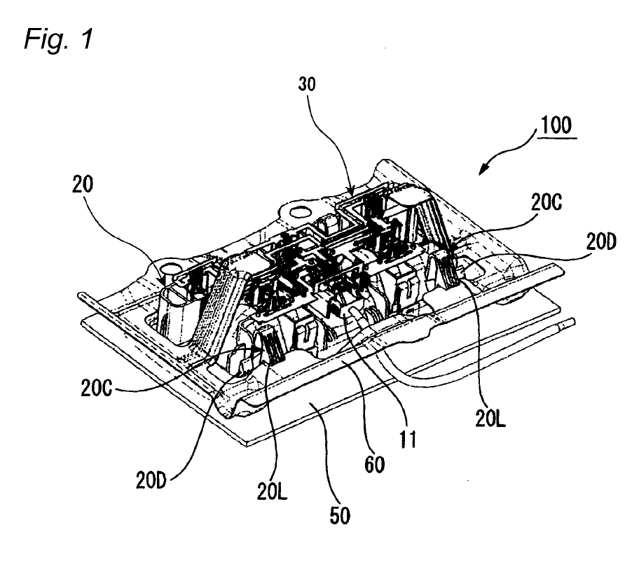

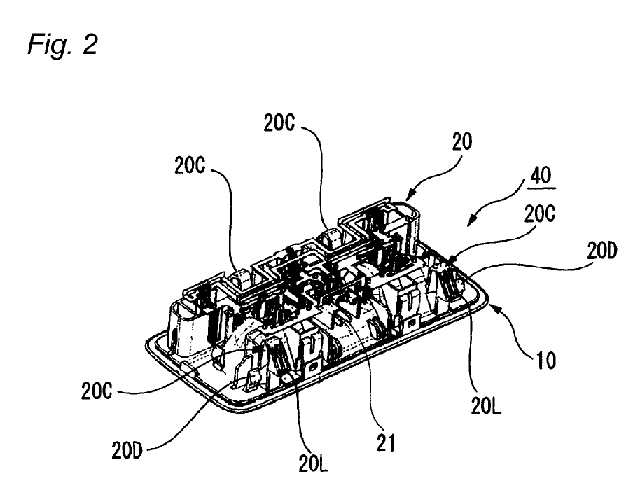

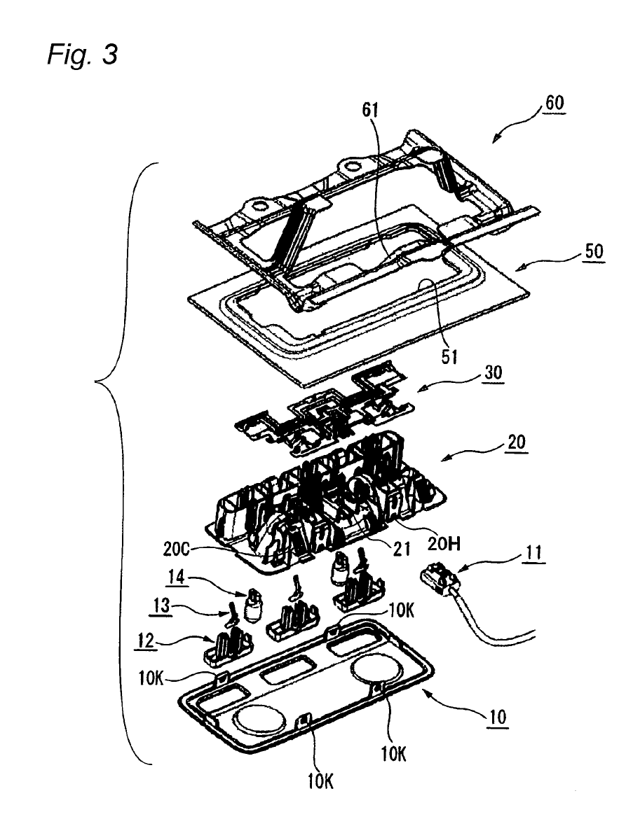

FIG. 1 is a perspective view of a vehicle room lamp 100 illustrating the vehicle room lamp in a state of being assembled to a vehicle according to an embodiment of the present invention, FIG. 2 is a perspective view of a lamp assembly 40 constituted by the remainder of the vehicle room lamp 100 illustrated in FIG. 1 from which a connector 11, a roof panel 50, and a reinforcement 60 are removed, and FIG. 3 is an exploded perspective view of the vehicle room lamp 100 illustrated in FIG. 1.

As illustrated in FIGS. 1 to 3, the lamp assembly 40 is integrally assembled by mounting a switch knob 12, a contact 13, and a valve 14 to a housing 20 illustrated in FIG. 3, fitting a busbar 30 for electrical connection from above to configure a lamp function part, fitting a lens 10 that constitutes a design part to the housing 20 from below, and locking four locking pieces 10K provided in the peripheral edge of the lens 10 into corresponding locking portions 20H of the housing 20.

As illustrated in FIG. 1, in the vehicle room lamp 100, the lamp assembly 40 is assembled to the roof panel 50 using resin clips 20C of the lamp assembly 40, and fitting the connector 11 to a connection portion 21 of the housing 20, thereby forming a roof module. Moreover, the roof module is assembled to the reinforcement 60 on a vehicle body side by using the resin clips 20C, thereby completing the vehicle room lamp 100 in the state of being assembled to a vehicle.

That is, in the vehicle room lamp 100 in the state of being assembled to a vehicle, the lamp assembly 40 is caused to approach the roof panel 50 from below and the resin clips 20C of the housing 20 included in the lamp assembly 40 are locked to an opening peripheral edge 51 of the roof panel 50 (primary locking), thereby forming the roof module. Next, the roof module is caused to approach the reinforcement 60 from below and the resin clips 20C of the housing 20 included in the lamp assembly 40 are locked to an opening peripheral edge 61 of the reinforcement 60 (secondary locking) (see FIG. 3). In addition, locking arms 20D are locked to the opening peripheral edge 51 of the roof panel 50 when the resin clips 20C are locked.

### Resin Clips 120C According To Related Art

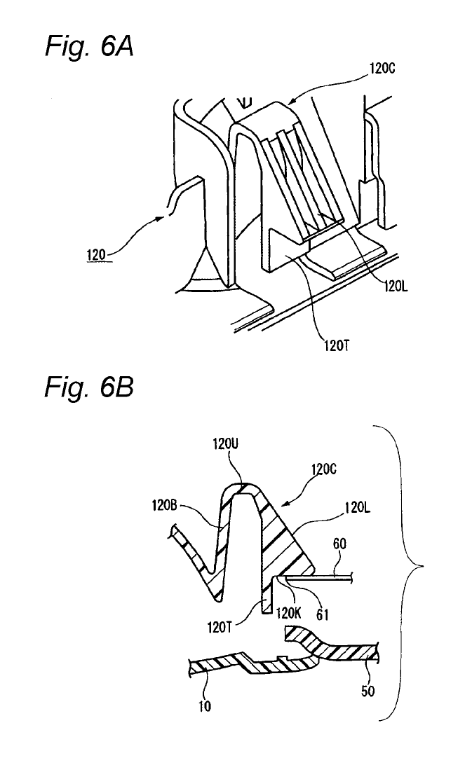

FIGS. 6A and 6B are diagrams illustrating resin clips 120C according to the related art at the four corners of a housing 120, where FIG. 6A is a perspective view and FIG. 6B is a longitudinal sectional view. In addition, the entire image of the housing 120 may be inferred or imaged with reference to the housing 20 of FIG. 2.

In FIG. 6, the resin clip 120C is one of the resin clips formed at the four corners of the housing 120.

As illustrated in FIG. 6B, the resin clip 120C is constituted by a base portion 120B connected to the housing 120, an inverted U-shaped portion 120U connected to the base portion 120B, a lock 120L that forms a hook (hook) portion 120K connected to the inverted U-shaped portion 120U, and a protruding piece 120T formed at the lower portion of the lock 120L, thereby forming a spring (spring) having an inverted U shape as a whole and elasticity due to the elasticity of the resin itself.

### Assembly By Resin Clips 120C

Since the resin clips 120C having elasticity are formed at the four corners of the housing 120, when the housing 120 is moved upward from below while causing the lock 120L of each of the four resin clips 120C to come into pressing contact with the opening peripheral edge 61 of the reinforcement 60, the lock 120L rides on the opening peripheral edge 61 of the reinforcement 60 through the inclined surface and the elasticity of the resin clip 120C, the hook portion 120K of the lock 120L is locked to the opening peripheral edge 61 of the reinforcement 60, so that the lamp assembly (see FIG. 2) including the housing 120 is assembled to the reinforcement 60 (see FIG. 3) in a state illustrated in FIG. 6B.

### Problem of Resin Clips 120C

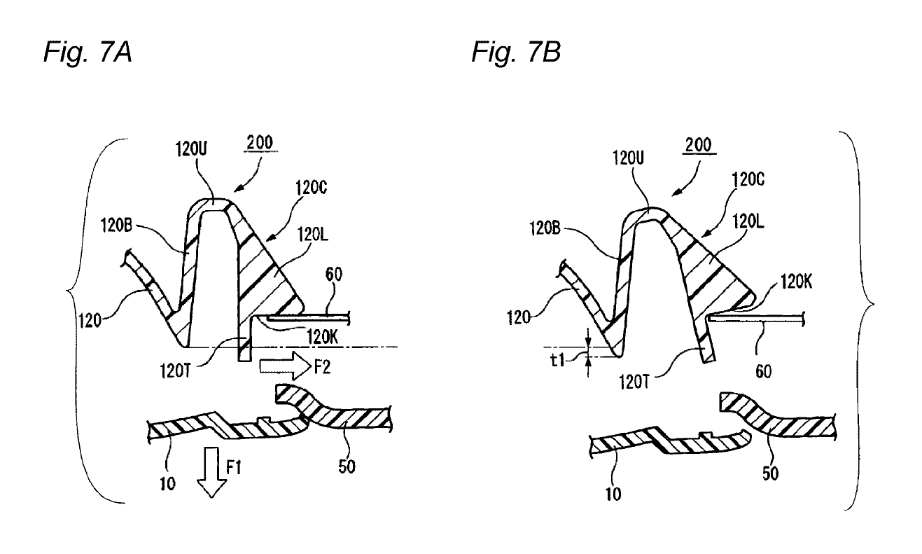

However, in a vehicle room lamp 200 assembled as described above, as illustrated in FIGS. 7A and 7B, when a force directed downward under the own weight of the lamp assembly, that is, a force in the direction of arrow F1 (see FIG. 7A) is exerted, the protruding piece 120T of the lower end portion of the lock 120L of the resin clip 120C moves in the direction of arrow F2 of FIG. 7A. As a result, the housing 120 is suspended by a distance t1 as in FIG. 7B, and thus there is a concern that an accurate mounting state may not be maintained.

The embodiment of the present invention (this embodiment) is made to further solve the problem, and an object thereof is to provide a vehicle room lamp in which, even though the lower end portion of the resin clip is impelled to open outward due to the own weight of the lamp assembly after mounting, the lower end portion is caused not to open, and thus the housing is not suspended.

### Shape of Resin Clip 20C According To This Embodiment

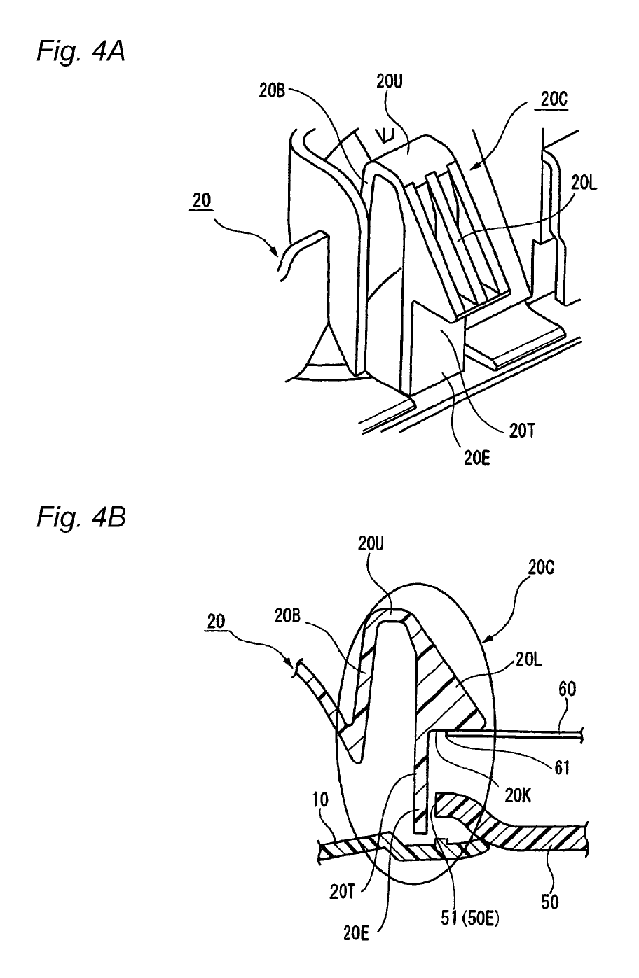

FIGS. 4A and 4B are diagrams illustrating the resin clip 20C according to the embodiment of the present invention in which a housing is not suspended, where FIG. 4A is a perspective view and FIG. 4B is a longitudinal sectional view.

In FIGS. 4A and 4B, the resin clip 20C is a resin clip positioned forward on the left from among the resin clips formed at the four corners of the housing 20 (see FIG. 2.).

As can be seen from FIG. 4B, the resin clip 20C according to this embodiment includes a base portion 20B connected to the housing 20, an inverted U-shaped portion 20U connected to the base portion 20B, a lock 20L that forms a hook portion 20K connected to the inverted U-shaped portion 20U, a protruding piece 20T formed at the lower portion of the lock 20L, and an extending portion 20E that is connected to the protruding piece 20T and further extends downward.

The resin clip 20C of this embodiment illustrated in FIGS. 4A and 4B is different from the resin clip 120C of the related art illustrated in FIGS. 6A and 6B in that the protruding piece 20T of the lower end portion of the lock 20L is further provided with the extending portion 20E that is connected thereto and extends downward.

### Structure In Which Die Having Slide Structure Is Unnecessary

As illustrated in FIGS. 4A and 4B, the resin clip 20C of this embodiment does not have a part that is undercut in the vertical direction and thus may be molded through die cutting in the vertical direction. That is, molding with only upper and lower dies is possible without the use of a slide structure such as a die for forming a flexible arm described in PTL 1.

### Shape of Roof Panel 50 According To This Embodiment

On the other hand, as can be seen from FIG. 4B, the roof panel 50 according to this embodiment is formed so that the opening peripheral edge 51 of the roof panel 50 reaches the vicinity of the extending portion 20E of the resin clip 20C in a state where the resin clip 20C is locked to the opening peripheral edge 61 of the reinforcement 60. In addition, the end surface of the opening peripheral edge 51 becomes a clip abutting surface 50E.

The roof panel 50 according to this embodiment illustrated in FIGS. 4A and 4B is formed to reach the vicinity of the resin clip 20C as such, and the extending portion 20E of the resin clip 20C comes into contact with the clip abutting surface 50E of the roof panel 50 in use, which is one of features.

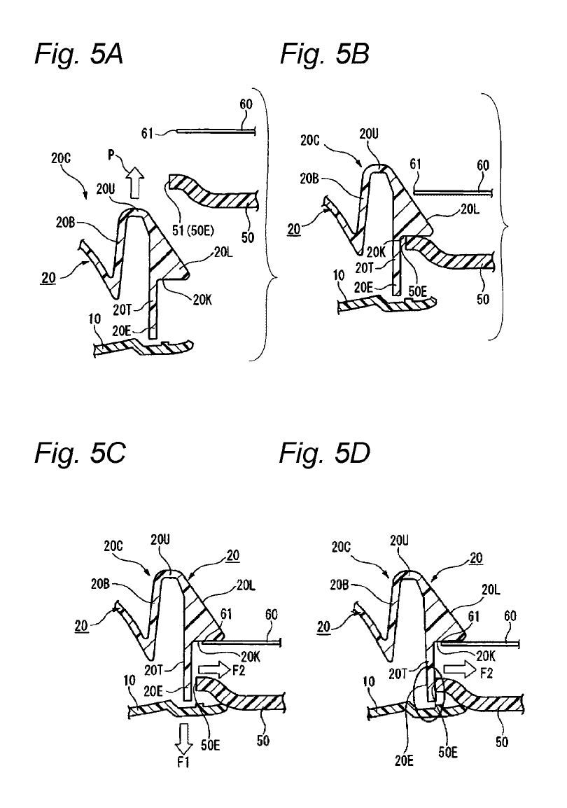

FIGS. 5A to 5D are longitudinal sectional views illustrating the order of assembling the resin clip 20C to the roof panel 50 and the reinforcement 60, where FIG. 5A, FIG. 5B, FIG. 5C, and FIG. 5D are diagrams illustrating the situation before assembly, primary locking, secondary locking, and suspension prevention, respectively.

As is apparent from FIG. 5A, the opening peripheral edge 51 of the roof panel 50 is raised upward from the base portion of the roof panel 50 to approach the reinforcement 60 and extends slightly to the left from the opening peripheral edge 61 of the reinforcement 60 in the figure (closer to the opening center).

In addition, the distance between the opening peripheral edge 51 of the roof panel 50 and the opening peripheral edge 61 of the reinforcement 60 is substantially the length from the hook portion 20K of the resin clip 20C to the end tip of the extending portion 20E.

### Assembly By Resin Clip 200

When the lock 20L of the resin clip 20C approaches in the direction of arrow P from below the roof panel 50, as in FIG. 5A, the lock 20L rides on the opening peripheral edge 51 of the roof panel 50 through the inclined surface and elasticity, and thus the hook portion 20K of the resin clip 20C is locked to the opening peripheral edge 51 as in FIG. 5B (primary locking).

Accordingly, the roof module is obtained. Then, when the roof module is further raised, the lock 20L rides on the opening peripheral edge 61 of the reinforcement 60 through the inclined surface and elasticity, and thus the hook portion 20K of the resin clip 20C is locked to the opening peripheral edge 61 of the reinforcement 60 as in FIG. 5C (secondary locking). Accordingly, the lamp assembly 40 (see FIG. 2) including the housing 20 is assembled to the reinforcement 60.

### Effect of Resin Clip 20C

In the vehicle room lamp 100 in state of being assembled to a vehicle obtained as described above, even when a force directed downward under the own weight of the lamp assembly 40 in use, that is, a force in the direction of arrow F1 (see FIG. 5C) is exerted, the extending portion 20E provided in this embodiment moves in the direction of arrow F2 and abuts on the clip abutting surface 50E of the roof panel 50 as in FIG. 5D. Therefore, the resin clip 20C is not further inclined, and thus the suspension of the housing 20 is prevented.

In addition, as illustrated in FIG. 5A, since the distance between the opening peripheral edge 51 of the roof panel 50 and the opening peripheral edge 61 of the reinforcement 60 is the length from the hook portion 20K of the resin clip to the end tip of the extending portion 20E, as illustrated in FIGS. 5C and 5D, even when a force is exerted downward under the own weight of the lamp assembly 40 (that is, the direction of the arrow F1), only a small force is exerted on the opening peripheral edge 51 of the roof panel 50 in the direction of arrow F2. Therefore, the strength of the roof panel 50 does not need to be high.

In addition, the resin clip 20C of this embodiment does not have a part that is undercut in the vertical direction as illustrated in FIGS. 4A and 4B and thus may be molded by die cutting in the vertical direction.

As described above, according to the vehicle room lamp 100 of this embodiment, a die having a slide structure which is the problem of the apparatus according to the related art is not used and excessive displacement due to suspension of a housing which is the problem of the related art may be prevented.

While the present invention has been described in detail with reference to the particular embodiments, it should be noted by those skilled in the art that various changes or modifications can be added without departing from the spirit and scope of the present invention.

This application is based on Japanese Patent Application (Patent Application 2010-108364) filed on May 10, 2010, the contents of which are incorporated herein by way of reference.

### INDUSTRIAL APPLICABILITY

According to the vehicle room lamp according to the present invention, there are advantages that since a die having a slide structure is not used, cost is reduced, and an accurate mounting state in which the housing is not suspended and does not cause excessive displacement due to the inclination after mounting of the resin clip that is used for the mounting can be maintained.

### REFERENCE SIGNS LIST

100 vehicle room lamp

10 lens

10K locking piece

11 connector

12 switch knob

13 contact

14 valve

20 housing

20B base portion

20C resin clip

20D locking arm

20E extending portion

20K hook portion

20L lock

20T protruding piece

20U inverted U-shaped portion

30 busbar

40 lamp assembly

50 roof panel

50E clip abutting surface

51 opening peripheral edge

60 reinforcement

61 opening peripheral edge

1. A vehicle room lamp comprising:
a lamp assembly integrally including a lens, a housing with a resin clip, and a busbar;
a roof panel having an opening; and
a reinforcement having an opening,
wherein the lamp assembly, the roof panel, and the reinforcement are integrally assembled by locking the resin clip to a peripheral edge of the opening of the reinforcement through the opening of the roof panel,
the resin clip is an elastic body, an entire shape of which is formed in an inverted U shape including a base portion connected to the housing, an inverted U-shaped portion connected to the base portion, and a lock connected to the inverted U-shaped portion,
the resin clip has an extending portion that further extends downward at a protruding piece at a lower end of the lock, and
a peripheral edge of the opening of the roof panel reaches a vicinity of the extending portion of the resin clip in a state where the resin clip is locked to the peripheral edge of the opening of the reinforcement.

2. The vehicle room lamp according to claim 1,
wherein a distance between the peripheral edge of the opening of the roof panel and the peripheral edge of the opening of the reinforcement is a length from a hook portion of the resin clip to an end tip of the extending portion.
